(19) United States
(12) Patent Application Publication
(10) Pub. No.: US 2004/0100562 A1
(43) Pub. Date: May 27, 2004

(54) Transmitting device, video camera device, transmitting method for the transmitting device, and transmitting method for the video camera device

(75) Inventors: Katsuei Ichikawa, Yokohama (JP); Tetsuo Nakano, Yokohama (JP); Shinya Imanishi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/623,320

(22) Filed: Jul. 18, 2003

(30) Foreign Application Priority Data
Nov. 21, 2002 (JP) 2002-338142

(51) Int. Cl. H04N 5/232; G06F 15/16

(52) U.S. Cl. 348/211.1; 709/232

(57) ABSTRACT

Disclosed is a transmitting device which is capable of transmitting data even if a communication line is disconnected while the data is being transmitted, wherein the device is provided with a plurality of communication interfaces 109 to 112 connectable to a plurality of respective communication lines and transmits data through the communication interfaces. If a communication line is disconnected while data is being transmitted, the transmitting device selects an appropriate communication line based on predetermined criteria for communication line connection, drives a communication interface corresponding to the communication line to connect to the communication line, and transmits the data.

### BACKGROUND OF THE INVENTION

The present invention relates to a transmitting device which is provided with a plurality of communication interfaces connectable to a plurality of respective communication lines and transmits data through the communication interfaces, a video camera device provided with the transmitting device, a transmitting method for the transmitting device, and a transmitting method for the video camera device.

In case of conventional monitoring systems, what is going on in an office or a store is remotely monitored as follows: analog signals, such as NTSC signals, are outputted from surveillance cameras installed on the monitored side. The signals are outputted to dedicated monitors on the monitoring side through dedicated lines, such as coaxial cables.

Along with the recent popularization of high-speed digital lines, such as ISDN and optical fibers, and the Internet, surveillance cameras called network surveillance camera are becoming increasingly widespread. The network surveillance camera is connectable directly to the Internet as a personal computer is connected to the Internet. Therefore, the network surveillance camera does not require lines dedicated to monitoring systems and are easy to install.

Further, with a personal computer connected to the Internet, images from surveillance cameras can be viewed on the personal computer. In this case, even a dedicated monitor is unnecessary. Recently, high-speed data communication by wireless LAN or wireless networks based on the IEEE 802.15.1 standard or the like has become common. Where these are used to connect a network surveillance camera to the Internet, it is unnecessary to connect a signal cable to the surveillance camera. This makes surveillance cameras easier to install.

There are various prior arts related to radio terminal devices using a plurality of types of radio communication. One of such prior arts is a radio terminal device provided with a plurality of radio communication methods, including wireless LAN, wireless networks based on the IEEE 802.15.1 standard or the like, and mobile communication. In this radio terminal device, the, most suitable communication method is selected based on the conditions of each communication line, communication cost, power consumption, and the like. Refer to, for example, Patent Document 1: JP-A No. 112347/2002.

In the surveillance camera and network surveillance camera described above as prior arts, one line is used as a communication line for transmitting image data. Therefore, if the line is disconnected due to communication failure or the communication speed is lowered due to congestion of the line, transmission of image data becomes unfeasible.

Also, there is a problem in cases where a plurality of communicating means are provided and the most suitable communication method is selected based on the conditions of communication lines, as described in Patent Document 1. No consideration is given to cases where the most suitable communication line selected is disconnected due to communication failure or congestion of the communication line during transmission of image data. Further, even if, after a communication line is disconnected, another communication line is connected to transmit image data, there is a problem. Image data generated while communication is interrupted is not transmitted. Further, no consideration is given to emergency situations, for example, a sensor for detecting any anomaly in a surveillance camera detecting an anomaly and power supply being interrupted due to power failure.

### SUMMARY OF THE INVENTION

An object of the present invention is to provide a transmitting device, a video camera device, and a transmitting method for the transmitting device, wherein data can be transmitted even if a communication line is disconnected while the data is being transmitted.

Another object of the present invention is to provide a transmitting device, a video camera device, and a transmitting method for the transmitting device, wherein data generated while a communication line is disconnected can be also transmitted.

A further object of the present invention is to provide a transmitting device, a video camera device, and a transmitting method for the transmitting device, wherein communication lines not in communication are effectively utilized while data is being transmitted.

A further object of the present invention is to provide a transmitting device, a video camera device, a transmitting method for the transmitting device, and a transmitting method for the video camera device, wherein data indicating any change in the situations of the transmitting device or the surrounding situations can be transmitted.

A further object of the present invention is to provide a transmitting device, a video camera device, and a transmitting method for the transmitting device, wherein higher-picture quality image data larger in amount can be transmitted and data can be transmitted even if a communication line is disconnected while the data is being transmitted.

A further object of the present inventions is to provide a transmitting device which is capable of transmitting data even in case of power failure.

One aspect of the present invention resides in a transmitting device which is provided with a plurality of communication interfaces connectable to a plurality of respective communication lines and transmits data through the communication interfaces. If a communication line is disconnected while data is being transmitted, this transmitting device selects an appropriate communication line based on predetermined criteria for communication line connection. Then, the transmitting device drives a communication interface corresponding to the communication line to connects to the communication line and transmits the data.

Another aspect of the present invention resides in a transmitting device which is provided with a plurality of communication interfaces connectable to communication lines and transmits data through the communication interfaces. This transmitting device is further provided with a data storing means for storing data to be transmitted. If a communication line is disconnected while data is being transmitted, the transmitting device selects an appropriate communication line based on predetermined criteria for communication line selection. The transmitting device drives a communication interface corresponding to the communication line to connect to the communication line. Then, the transmitting device transmits, together with data to be transmitted, the data which has been generated and stored in the data storing means while the line is disconnected.

Another aspect of the present invention resides in a transmitting device which is provided with a plurality of communication interfaces connectable to communication lines and transmits data through the communication interfaces. This transmitting device is further provided with a data storing means for storing data to be transmitted. While data is being transmitted, the transmitting device drives communication interfaces which are not transmitting to connect to communication lines corresponding to the communication interfaces. The transmitting device examines the conditions of the communication lines and acquires the up-to-date information about the communication lines. If a communication line is disconnected while data is being transmitted, the transmitting device selects an appropriate communication line based on criteria for communication line connection updated with the up-to-date information. The transmitting means drives a communication interface corresponding to the communication line to connect to the communication line. Then, the transmitting device transmits, together with data to be transmitted, the data which has been generated and stored in the data storing means while the line is disconnected.

Another aspect of the present invention resides in a transmitting device which is provided with a plurality of communication interfaces connectable to communication lines and transmits data through the communication interfaces. This transmitting device is further provided with a data storing means for storing data to be transmitted. While data is being transmitted, the transmitting device selects a communication interface which is not transmitting and connects to a communication line corresponding to the communication interface. The transmitting device externally acquires the up-to-date information about the conditions of communication lines through the communication line. If a communication line is disconnected while data is being transmitted, the transmitting device selects an appropriate communication line based on criteria for communication line connection with the up-to-date information taken into account. The transmitting device drives a communication interface corresponding to the communication line. Then, the transmitting device transmits, together with data to be transmitted, the data which has been generated and stored in the data storing means while the line is disconnected.

Another aspect of the present invention resides in a transmitting device which is provided with a plurality of communication interfaces connectable to communication lines and transmits data through the communication interfaces. This transmitting device is further provided with a data storing means for storing data to be transmitted. If a communication line is disconnected while data is being transmitted, the transmitting device selects a plurality of appropriate communication lines based on predetermined criteria for communication line connection. The transmitting device drives a plurality of communication interfaces corresponding to a plurality of the communication lines to connect to a plurality of the communication lines. Then, the transmitting device transmits the data generated and stored in the data storing means while the line is disconnected and data to be transmitted, through different communication lines of a plurality of the connected communication lines.

Another aspect of the present invention resides in a video camera device provided with the transmitting device described in any of the foregoing paragraphs and an image pickup portion. Data transmitted by the transmitting device is the data of images picked up by the image pickup portion.

Another aspect of the present invention resides in a transmitting device which is provided with a plurality of communication interfaces connectable to communication lines and transmits data through the communication interfaces. This transmitting device is further provided with a data storing means for storing data to be transmitted and a sensor for detecting any change in the situations of the transmitting device or the surrounding situations. If the sensor detects any change in the situations while data is being transmitted, the transmitting device continues to transmit the data. The transmitting device further connects a communication interface which is not in communication to connect to a communication line corresponding to the communication interface. Then, the transmitting device transmits data which was generated round about the time when the change in the situations occurred and has been stored in the data storing means, through the communication line.

Another aspect of the present invention resides in a video camera device which includes an image pickup portion; and a compressing portion which compresses the data of images picked up by the image pickup portion. This video camera device is also provided with a transmitting device which is provided with a plurality of communication interface connectable to communication lines and transmits compressed image data compressed by the compressing portion, through the communication interfaces. The video camera device is further provided with a data storing means for storing high-picture quality data lower in data compression ratio than compressed image data to be transmitted. The video camera device is further provided with a sensor for detecting any change in the situations of the transmitting device or the surrounding situations. If the sensor detects any change in the situations while the compressed image data is being transmitted, the video camera device drives a communication interface which is not transmitting to connect to a communication line corresponding to the communication interface. Then, the video camera device transmits the high-picture quality data stored in the data storing means.

Another aspect of the present invention resides in a transmitting device provided with a data dividing portion which divides data to be transmitted. This transmitting device transmits the individual pieces of data divided by the data dividing portion in parallel using a plurality of communication interfaces. If a communication line is disconnected while data is being transmitted, the transmitting device re-divides data to be transmitted divided by the data dividing portion into a number corresponding to the number of the remaining communication lines. Then, the transmitting device transmits the re-divided data through the remaining communication lines.

Another aspect of the present invention resides in a video camera device provided with the above-mentioned transmitting device and an image pickup portion. Divided data transmitted by the transmitting device is image data obtained by dividing the data of images picked up by the image pickup portion.

Another aspect of the present invention resides in a transmitting device wherein the transmitting device or video camera device described in any of the foregoing paragraphs is provided with a battery. In case of power failure, the power supply to the transmitting device is switched to the battery. If the transmitting device is transmitting data at this time, the transmitting device selects, from among a plurality of communication interfaces, a communication interface corresponding to a communication line lowest in power consumption when connected. Then, the transmitting device drives the communication interface to connect to the communication line and transmits data.

Another aspect of the present invention resides in the above-mentioned transmitting device provided with a battery. In case of power failure, the power supply to the transmitting device is switched to the battery. If the transmitting device is transmitting divided data through a plurality of communication lines at this time, the transmitting device performs the following: the transmitting device selects, from among a plurality of communication interfaces which are in communication, only a communication interface corresponding to a communication line lowest in power consumption. Then, the transmitting device drives the communication interface to connect to the communication line and transmits data.

Another aspect of the present invention resides in the transmitting device described in any of the foregoing paragraphs which transmitting device is provided with a sensor for detecting any change in the situations of the transmitting device or the surrounding situations. If the sensor detects any change in the situations when the transmitting device is transmitting data through a communication interface lowest in power consumption during power failure, the transmitting device performs the following: the transmitting device selects, from among a plurality of the communication interfaces, a communication interface corresponding to a communication line highest in communication speed. Then, the transmitting device drives the communication interface and transmits data.

Another aspect of the present invention resides in the transmitting device described in any of the foregoing paragraphs, wherein the criteria for communication line connection includes at least one of the following: communication speed, communication cost, power consumption, the reliability of line connection, the conditions of communication lines, the conditions of the transmitting device, and the conditions of a receiver as the destination of transmission.

Another aspect of the present invention resides in a transmitting method for a transmitting device which is provided with a plurality of communication interfaces connectable to communication lines and transmits data through the communication interfaces. By this method, if a communication line is disconnected while data is being transmitted, the transmitting device drives a communication interface corresponding to another communication line to connect to the communication line. Then, the transmitting device transmits data.

Another aspect of the present invention resides in a transmitting method for a transmitting device which is provided with a plurality of communication interfaces connectable to communication lines and transmits data through the communication interfaces. By this method, if a communication line is disconnected while data is being transmitted, the transmitting device drives a communication interface corresponding to another communication line to connect to the communication line. Then, the transmitting device transmits, together with data to be transmitted, data stored while the communication line is disconnected.

Another aspect of the present invention resides in a transmitting method for a transmitting device which is provided with a plurality of communication interfaces connectable to communication lines and transmits data through the communication interfaces. By this method, if a communication line is disconnected while data is being transmitted, the transmitting device drives a plurality of communication interfaces corresponding to a plurality of other communication lines to connect to a plurality of the communication lines. Then, the transmitting device transmits data stored while the communication line is disconnected and data to be transmitted through different communication lines of a plurality of the connected communication lines.

Another aspect of the present invention resides in a transmitting method for a transmitting device which is provided with a plurality of communication interfaces connectable to communication lines and transmits data through the communication interfaces. By this method, if there is any change in the situations of the transmitting device or the surrounding situations while data is being transmitted, the transmitting device continues to transmit the data. The transmitting device further connects a communication interface which is not in communication and connects to a communication line corresponding to the communication interface. Then, the transmitting device transmits data generated round about the time when the change in situations occurred.

Another aspect of the present invention resides in a transmitting method for a video camera device comprising an image pickup portion; a compressing portion which compresses the data of images picked up by the image pickup portion; and a transmitting device which is provided with a plurality of communication interfaces connectable to communication lines and transmits compressed image data compressed by the compressing portion, through the communication interfaces, and a sensor for detecting any change in the situations of the transmitting device or the surrounding situations. By this method, if the above-mentioned sensor detects any change in the above-mentioned situations while compressed image data is being transmitted, the video camera device drives a communication interface which is not transmitting to connect a communication line corresponding to the communication interface. Then, the video camera device transmits high-picture quality data lower in data compression ratio than the stored compressed image data.

Another aspect of the present invention resides in a transmitting method for a transmitting device which transmits a plurality of pieces of divided data in parallel, using a plurality of communication interfaces. By this method, if a communication line is disconnected while data is being transmitted, the transmitting device re-divides data to be transmitted into a number corresponding to the remaining communication lines. Then, the transmitting device transmits the re-divided data through the remaining communication lines.

Other and further objects, features and advantages of the invention will appear more fully from the following description.

### BRIEF DESCRIPTION OF THE DRAWINGS

FIG. 1 is a block diagram illustrating an entire monitoring system using the video camera device of the present invention.

FIG. 2 is a flowchart illustrating a first embodiment of the video camera device of the present invention.

FIG. 3 is a flowchart illustrating a second embodiment of the video camera device of the present invention.

FIG. 4 is a flowchart illustrating a third embodiment of the video camera device of the present invention.

FIG. 5A is a drawing illustrating an example of criteria for communication line selection for the video camera device of the present invention to select the most suitable communication line.

FIG. 5B is a drawing illustrating another example of criteria for communication line selection for the video camera device of the present invention to select the most suitable communication line.

FIG. 6 is a flowchart illustrating a fourth embodiment of the video camera device of the present invention.

FIG. 7 is a schematic diagram illustrating the operation of the video camera device in the fourth embodiment of the present invention.

FIG. 8 is a flowchart illustrating a fifth embodiment of the video camera device of the present invention.

FIG. 9 is a schematic diagram illustrating the operation of the video camera device in the fifth embodiment of the present invention.

FIG. 10 is a block diagram of an entire monitoring system, illustrating a sixth embodiment of the video camera device of the present invention.

FIG. 11 is a flowchart illustrating a seventh embodiment of the video camera device of the present invention.

FIG. 12 is a flowchart illustrating an eighth embodiment of the video camera device of the present invention.

### DESCRIPTION OF THE PREFERRED EMBODIMENTS

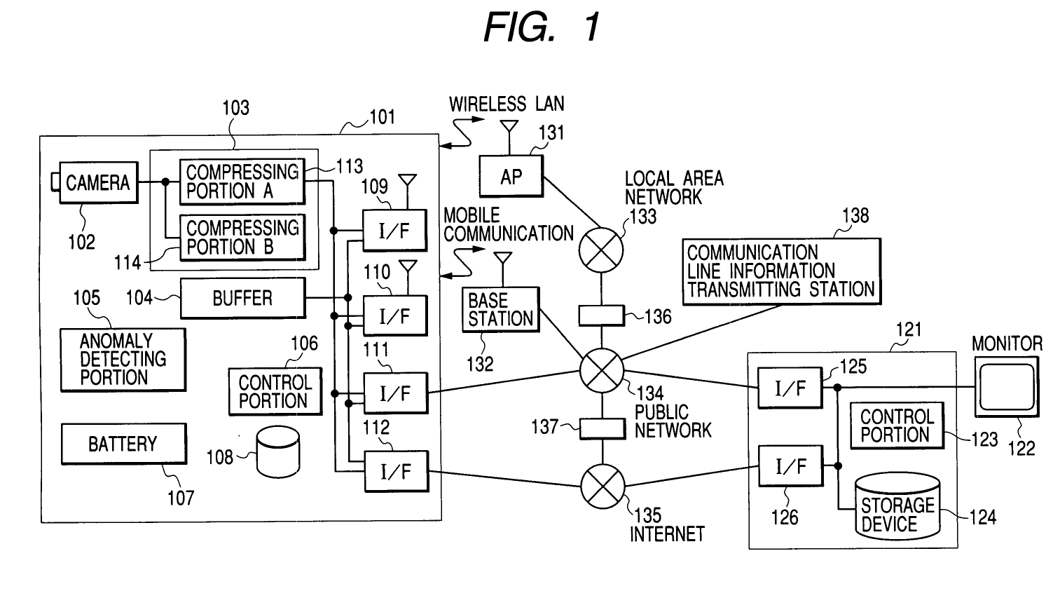

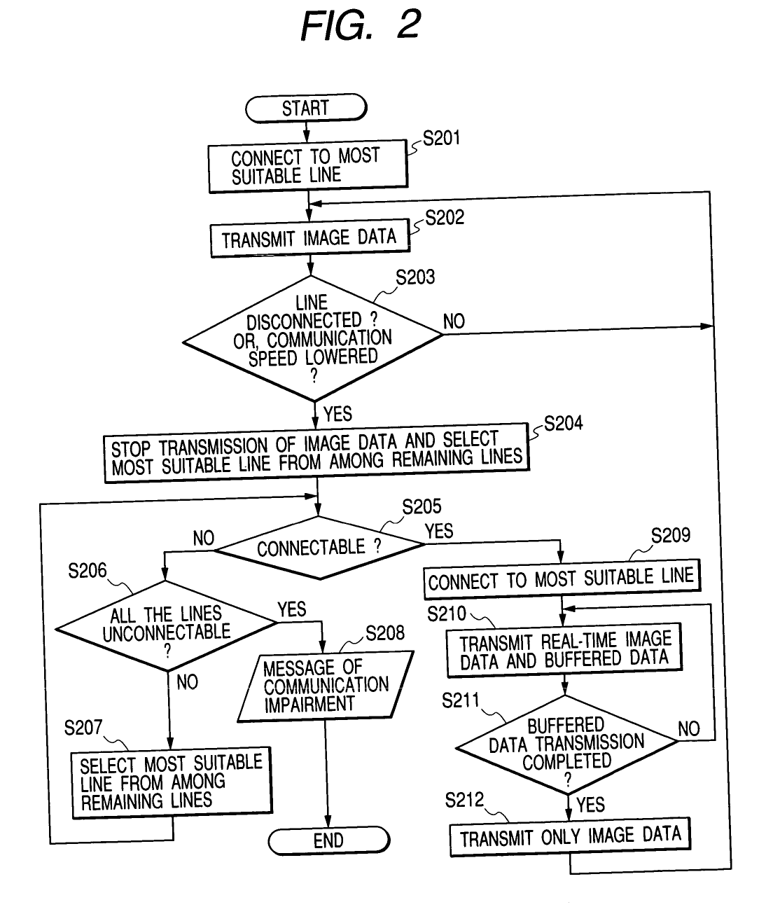

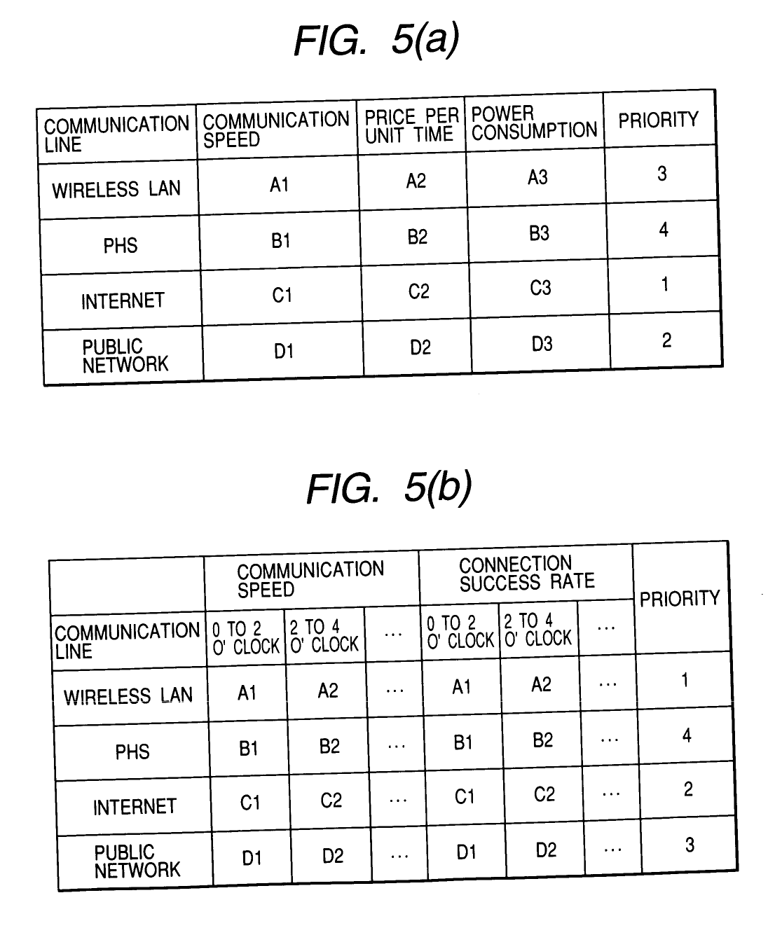

Referring to FIG. 1, FIG. 2, and FIG. 5A, the first embodiment of the video camera device of the present invention will be described.

FIG. 1 is a block diagram of the entire monitoring system including a network surveillance camera, a communication lines connected thereto, and a monitoring device which receives the data of images picked up by the network surveillance camera. The network surveillance camera in the figure is an embodiment of the video camera device of the present invention.

The monitoring system in FIG. 1 comprises a network surveillance camera 101; a controller 121 which receives image data from the network surveillance camera 101 and further controls the surveillance camera; a monitor 122 which displays image data from the network surveillance camera 101; a wireless LAN access point (equivalent to base station in mobile communication) 131; a local area network (LAN) 133 to which the wireless LAN access point 131 is connected; a base station 132 in mobile communication; a communication line information transmitting station 138 which transmits information about the conditions of each communication line; a public network 134 to which the base station 132 and the communication line information transmitting station 138 are connected; the Internet 135; and interfaces 136 and 137 which connect together the communication networks.

Further, the network surveillance camera 101 comprises a camera 102; a compressing unit 103 which compresses image data from the camera 102; a buffer 104 which stores image data for a certain period of time; an anomaly detecting portion 105 which detects any anomaly on the monitored side; a control portion 106 which controls the network surveillance camera 101; a battery 107 which battery-drives the network surveillance camera 101 at the time of power failure; a storage device 108 which stores image data and information about criteria for communication line connection; and communication interfaces 109, 110, 111, and 112 which are connected with communication lines. Further, the compressing unit 103 comprises a compressing portion A 113 which compresses image data from the camera 102 and outputs the compressed image data to the communication interfaces 109 to 112; and a compressing portion B 114 which compresses image data from the camera 102 and outputs the compressed image data to the buffer 104.

The controller 121 comprises communication interfaces 125 and 126 for receiving image data from the network surveillance camera 101; a control portion 123 which controls the controller 121; and a storage device 124 which stores image data from the network surveillance camera 101 and the like.

The monitor 122 is connected to the communication interfaces 125 and 126 of the controller 121.

Next, referring to FIG. 5A, an example of information about criteria for communication line connection, stored in the storage device 108 of the network surveillance camera 101 will be described. In the example illustrated in the figure, communication speed, communication cost per unit time, and power consumption are recorded for each connectable communication line. The control portion 106 refers to this information to determine the order of priorities of communication interfaces to be connected. For example, where a request for detailed images is made from the controller 121, the control portion 106 refers to the information described in FIG. 5A to give priorities to the communication lines in descending order of communication speed. Then, the control portion 106 selects a communication line of the highest priority. Or, where the network surveillance camera 101 is driven by the battery 107 because of power failure or the like, the control portion 106 refers to the information described in FIG. 5A to give priorities to the communication lines in ascending order of power consumption. Then, the control portion 106 selects a communication line of the highest priority.

Description will be given to the operation performed in the above-mentioned monitoring system when images picked up by the network surveillance camera 101 are outputted to the monitoring-side monitor 122.

The data of images obtained by shooting a monitored object by the camera 102 is compressed by the compressing portion B 114 of the compressing unit 103. The compressed data is thereafter stored as image data in the buffer 104 for a certain period of time. Further, the image data from the camera 102 is compressed by the compressing portion A 113 of the compressing unit 103 and outputted to the communication interfaces 109 to 112.

When a request to transmit image data is made from the monitoring-side controller 121, the control portion 106 of the network surveillance camera 101 refers to the information about the conditions of the communication lines, such as the communication speed and the communication cost of each communication line, stored in the storage device 108. Thus, the control portion 106 selects a communication interface of the highest priority from among the communication interfaces 109 to 112 based on the order of priorities. This order of priorities is determined based on the above information, taking into account presence/absence of a request for high-picture quality data from the controller 121, presence/absence of power failure on the monitoring side, and the like. Then, the control portion 106 transmits the image data stored in the buffer 104 to the monitoring-side controller 121 through the selected communication line. The control portion 123 of the controller 121 receives the transmitted image data through a communication interface corresponding to the communication line used for this transmission. Then, the control portion 123 outputs the data to the monitor 122.

Next, referring to FIG. 1 and the flowchart in FIG. 2, description will be given to the operation performed in the following case: a communication line is disconnected due to communication failure while image data is being transmitted from the network surveillance camera 101. Consequently, another line is connected to transmit the data. The following case will be taken as an example of changing communication lines: while the network surveillance camera is in connection to the Internet 135 and data is being transmitted, the line is disconnected due to congestion of the line or the like. Consequently, the network surveillance camera connects to the public network 134 as the most suitable line among the remaining lines, and transmits the data.

When a request to transmit is made from the controller 121, the control portion 106 refers to the information about the conditions of the communication lines, stored in the storage device 108. Based on this information, the control portion 106 connects the controller 121 to a communication line of the highest priority (the Internet 135 in this example), and transmits image data (Steps 201 and 202).

When there is not disconnection of the line or the like, the data is transmitted through the connected line. If the communication line is disconnected or if the communication speed of the communication line is lowered and data transmission becomes unfeasible (Step 203), the control portion 106 stops the transmission of image data. (However, image data from the camera 102 is constantly stored in the buffer 104.) The control portion 106 further refers to the information about criteria for communication line connection, stored in the storage device 108. Based on this information, the control portion 106 selects a communication line of the highest priority (public network 134 in this example) from among the remaining lines. Then, the control portion 106 turns on a communication interface corresponding thereto (communication interface 111 in this example), and starts connection with the communication line (Step 204).

When the selected communication line is connectable, the control portion 106 connects to the communication line (Steps 205 and 209). The control portion 106 transmits image data outputted from the compressing unit 103, through the connected communication line. At the same time, the control portion 106 transmits image data generated while image data transmission is interrupted, among the image data stored in the buffer 104 (Step 210).

At this time, two pieces of image data can be simultaneously transmitted through one line by taking, for example, the following measures: image data outputted from the compressing portion A 113 of the compressing unit 103 and image data from the buffer 104 are compressed or subjected to any other processing through a communication interface through which both the pieces of data are transmitted (communication interface 111 in this example). Then, the pieces of data are displayed on the left and right split screens of the monitor 122. Or, images from the buffer 104 are inserted as a sub-screen into part of images outputted from the compressing portion A 113 of the compressing unit 103.

When transmission of image data generated while data transmission is interrupted is completed, the control portion 106 transmits only image data from the compressing portion A 113 of the compressing unit 103 (Steps 211 and 212).

If the selected communication line is not connectable due to communication failure or the like at Step 205, the control portion 106 checks whether a communication line of the next highest priority is connectable (Steps 206 and 207). If none of the communication lines is connectable, the control portion 123 of the controller 121 outputs a message indicating communication impairment to the monitor 122 and stops transmission (Step 208).

In the above-mentioned first embodiment, the video camera device has a plurality of communication interfaces connectable to a plurality of communication lines. Further, if a communication line is disconnected while image data is being transmitted, the video camera device is capable of transmitting the image data through the most suitable line among the remaining lines. More specifically, the video camera device selects the most suitable line from among a plurality of communication lines, and, after the communication line is connected, transmits image data generated while transmission is interrupted.

Thus, after the communication line is connected, image data generated while communication is interrupted can be transmitted together with the current image data. Therefore, a video camera device which is less prone to be influenced by degradation or variation in the communicating conditions of communication lines is obtained.

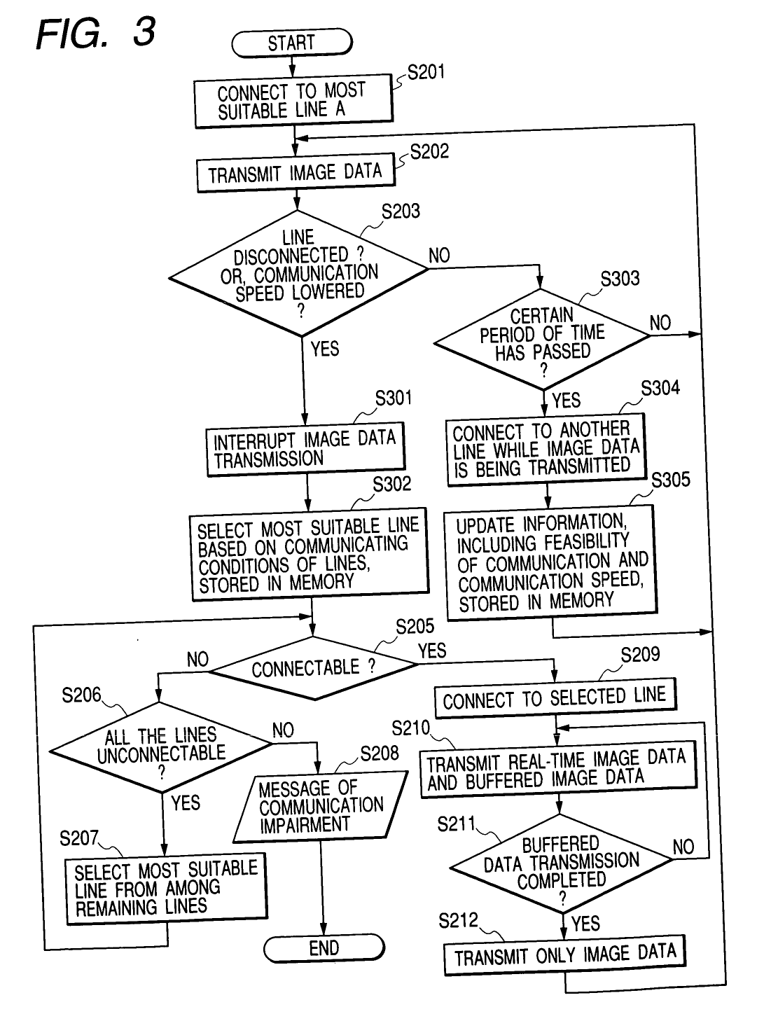

Referring to FIG. 1, FIG. 3, and FIG. 5B, the second embodiment of the video camera device of the present invention will be described.

First, referring to FIG. 1, as for the first embodiment, description will be given to the operation performed in the following case in the second embodiment of the video camera device of the present invention: images picked up by the network surveillance camera 101 are outputted to the monitoring-side monitor 122.

There is a difference between the operation in the first embodiment and the operation in the third embodiment. In the third embodiment, while image data from the compressing portion A 113 of the compressing unit 103 is being transmitted, communication interfaces which are not transmitting data are periodically turned on. Then, information about the communication lines, such as communication speed, is acquired, and information about criteria for communication line connection, stored in the storage device 108 is updated. The other points are the same as with the first embodiment.

Next, referring to FIG. 5B, description will be given to an example of information about criteria for communication line connection, obtained by periodically turning on the communication lines.

In the example illustrated in the figure, the average communication speed at each hour and the connection success rate indicating to what extent connection is actually established are recorded for each communication line. As mentioned above, the lines are periodically connected in the second embodiment. Therefore, statistics can be taken on an hour-by-hour basis, and the mean communication speed and connection success rate at each hour can be obtained for each communication line.

Next, referring to FIG. 1 and the flowchart in FIG. 3, description will be given to the operation performed when a communication line is disconnected while data is being transmitted. The same actions as taken in the first embodiment will be provided with the same numbers and the description thereof will be omitted.

In FIG. 3, when a request to transmit is made from the controller 121 illustrated in FIG. 1, the control portion 106 refers to information about the communication lines previously stored in the storage device 108. Based on this information, the control portion 106 selects a communication interface of the highest priority and connects thereto (Step 201). Then, the control portion 106 transmits image data to the monitoring-side controller 121 through the selected communication line (Step 202).

After a certain period of time has passed while the image data is being transmitted, the control portion 106 turns on communication interfaces which are not transmitting (Steps 203, 303, and 304). The control portion 106 thereby checks information about the communication lines, including the availability to communication and communication speed of the lines which are not transmitting data and the conditions of the receiver as the destination of transmission. Then, the control portion 106 updates information about the conditions of the communication lines, stored in the storage device 108 (Step 305).

If the communication line is disconnected or the communication speed of the communication line is lowered and data transmission becomes unfeasible at Step 203, the control portion 106 stops the transmission of image data (Step 301). Then, the control portion 106 reads information about the conditions of the communication lines, stored in the storage device 108. Based on this information, the control portion 106 selects a communication interface of the highest priority from among the remaining communication lines (Step 302). When the selected line is connectable, the control portion 106 transmits image data generated and stored in the buffer 104 while communication is interrupted, together with image data outputted from the compressing portion A 113 of the compressing unit 103 (Steps 205, 209, and 210). If the selected communication line is not connectable, the control portion 106 establishes connection through the still remaining communication interfaces (Steps 205 and 207).

As mentioned above, in the second embodiment of the video camera device, the same effect as in the first embodiment is produced. Further, the conditions of the communication lines are periodically grasped. Therefore, the most suitable communication line is selected and the connection success rate is improved, which makes it possible to shorten the average connect time of the communication lines.

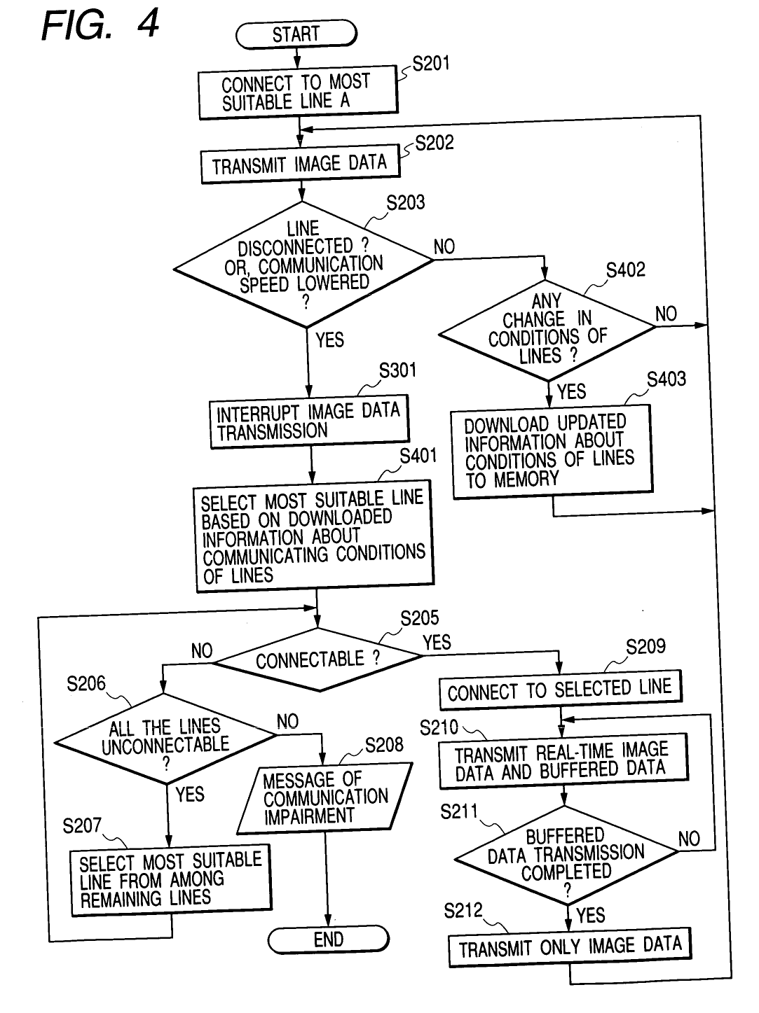

Next, referring to FIG. 1 and FIG. 4, the third embodiment of the video camera device of the present invention will be described. First, referring to FIG. 1, as for the first embodiment, description will be given to the operation performed in the following case in the third embodiment of the video camera device of the present invention: images picked up by the network surveillance camera 101 are outputted to the monitoring-side monitor 122.

There is a difference between the operation in the first embodiment and the operation in the third embodiment. In the third embodiment, the control portion 106 acquires information about the conditions of the communication lines from the communication line information transmitting station 138 through a communication line which is not transmitting data. The control portion 106 thereby updates information about criteria for communication line connection, stored in the storage device 108. The other points are the same as with the first embodiment.

Next, referring to FIG. 1 and the flowchart in FIG. 4, the operation performed when a communication line is disconnected while data is being transmitted. The same actions as taken in the first embodiment and the second embodiment will be provided with the same numbers and the description thereof will be omitted.

In FIG. 4, when a request to transmit is made from the controller 121 in FIG. 1, the control portion 106 refers to information about the communication lines previously stored in the storage device 108. Based on this information, the control portion 106 selects a communication interface of the highest priority and connects thereto (Step 201). Then, the control portion 106 transmits image data to the monitoring-side controller 121 through the connected communication line (Step 202).

At this time, the control portion 106 reads information about the conditions of the communication lines from the communication line information transmitting station 138 through a connectable line among the communication lines which are not transmitting data. If there is any change from the information about the conditions of the communication lines, stored in the storage device 108, the control portion 106 downloads updated information about the conditions of the communication lines (Steps 402 and 403).

If the communication line is disconnected or the communication speed of the communication line is lowered and data transmission becomes unfeasible, the control portion 106 stops the transmission of image data (Step 203 and 301). Then, the control portion 106 reads the information about the conditions of the communication lines, stored in the storage device 108. Based on this information, the control portion 106 selects the most suitable line from among the remaining communication lines (Step 401).

When the selected line is connectable, the control portion 106 transmits image data generated and stored in the buffer 104 while the line is disconnected, together with image data outputted from the compressing portion A 113 of the compressing unit 103 (Steps 205, 209, and 210). If the selected communication line is not connectable, the control portion 106 establishes connection through the still remaining lines (Steps 205, 206, and 207).

As mentioned above, in the third embodiment of the video camera device, the same effect as in the first embodiment is produced. Further, information about the conditions of the communication lines is acquired from the communication line information transmitting station 138 as needed. Therefore, the most suitable communication line is selected and the connection success rate is improved, which makes it possible to shorten the average connect time of the communication lines.

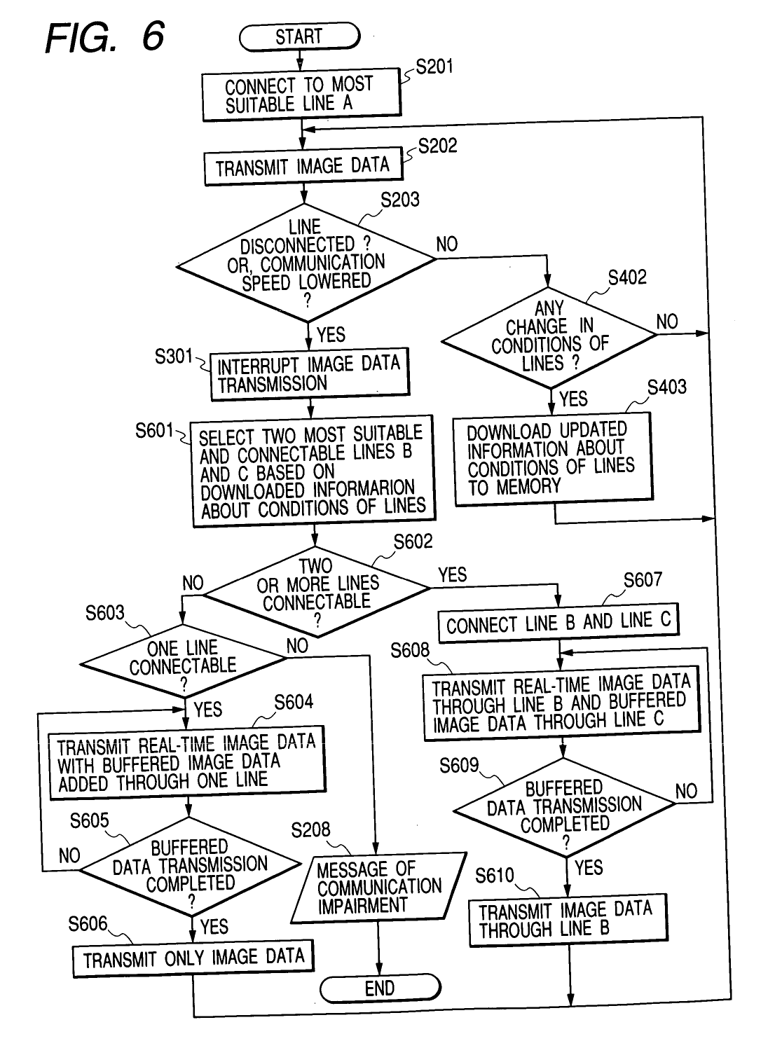

Next, referring to FIG. 1 and FIG. 6, the fourth embodiment of the video camera device of the present invention will be described. In the fourth embodiment as well, images picked up by the network surveillance camera. 101 are outputted to the monitoring-side monitor 122. The operation performed at this time is the same as in the third embodiment. Therefore the description thereof will be omitted.

Next, referring to FIG. 1 and the flowchart in FIG. 6, description will be given to the operation performed when a communication line is disconnected while image data is being transmitted from the network surveillance camera 101 and another line is connected to transmit the data.

The following case will be taken as an example of changing communication lines: while the network surveillance camera is in connection to an access point 131 in wireless LAN, this line is disconnected. Consequently, the network surveillance camera connects to a plurality of communication lines, that is, the public network 134 and the Internet 135, among the remaining lines.

When a request to transmit is made from the controller 121, the control portion 106 refers to information about the communication lines previously stored in the storage device 108. Based on this information, the control portion 106 connects to communication line A of the highest priority (access point 131 in wireless LAN in the example) and transmits image data (Steps 201 and 202). In this example, image data is transmitted from the access point 131 in wireless LAN to the controller 121 through the local area network 133, the interface 136, and the public network 134.

Where the line is not disconnected or any like event does not occur at this time, data is transmitted through the connected line (Step 203). If the communication line is disconnected (Step 203), the control portion 106 stops the transmission of image data (Step 301). (However, image data from the camera 102 is constantly transmitted through the compressing portion B 114 of the compressing unit 103 and stored in the buffer 104.) The control portion 106 further refers to the information about criteria for communication line connection, stored in the storage device 108. Based on this information, the control portion 106 selects communication line B and communication line C of the highest priority (public network 134 and the Internet 135 in the example) from among the remaining lines (Step 601).

When the selected communication lines B and C are connectable, the control portion 106 connects thereto (Step 607). Then, the control portion 106 transmits image data outputted from the compressing portion A 113 of the compressing unit 103 through the communication line B (Step 608). At the same time, the control portion 106 transmits image data generated and stored in the buffer 104 while transmission is interrupted, through the communication line C (Step 608). When the transmission of the image data stored in the buffer 104 is completed, the control portion 106 disconnects the communication line C. Thereafter, the control portion 106 transmits only the image data from the compressing unit 103 through the communication line B (Steps 609 and 610).

If either of the selected communication lines B and C is unconnectable due to communication failure or the like at Step S602, the control portion 106 transmits as in the third embodiment. More specifically, the control portion 106 transmits image data in the buffer 104, together with the image data from the compressing portion A 113 of the compressing unit 103, through one communication line (Steps 604 to 606). If there is not a connectable communication line at Step S603, the control portion 123 of the controller 121 outputs a message indicating communication impairment to the monitor 122 and stops the transmission (Step 208).

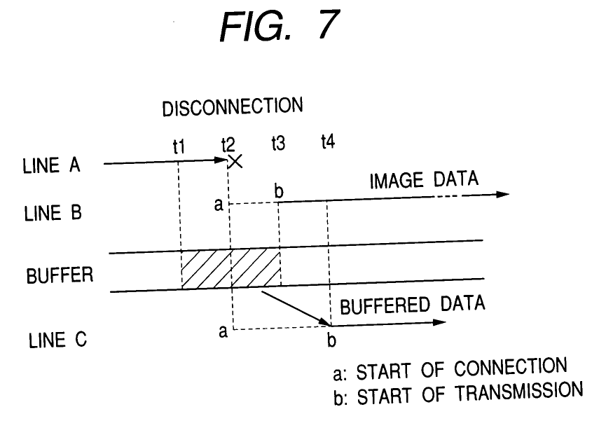

With respect to the above-mentioned fourth embodiment, referring to FIG. 7, detailed description will be given again to the operation performed in the following case: a communication line is disconnected while image data is being transmitted and another line is connected to transmit the data. The figure is a schematic diagram wherein both the flow of time and the flow of data are represented in the horizontal direction. It is assumed that, while image data outputted from the compressing unit 103 is being transmitted through the communication line A, the line is disconnected at t2. At this time, the communication lines B and C are selected as the most suitable lines and connection is started. When the connection to the communication line B is established at t3, image data outputted from the compressing unit 103 is outputted through the communication line B. When the connection to the communication line C is established at t4, data buffered while transmission is interrupted, that is, during the period from t2 to t3, is transmitted through the communication line C.

In the above-mentioned fourth embodiment of the video camera device, the same effect as in the third embodiment is produced. Further, if a communication line is disconnected while image data is being transmitted, a plurality of communication lines are connected. Then, image data outputted from the compressing unit 103 and image data in the buffer 104 can be transmitted through separate communication lines. Therefore, unlike cases where image data and buffered image data are simultaneously transmitted through one line, either image data need not be reduced in amount when transmitted. (In other words, the data compression ratio need not be increased.)

Further, the data compression ratio of the compressing portion B 114 of the compressing unit 103 can be made lower than that of the compressing portion A 113. Thus, when image data is stored in the buffer 104, the picture quality thereof can be made higher than that of image data transmitted through the compressing portion A 113. As a result, buffered image data of higher quality can be transmitted. Further, depending on the capacity of the buffer 104, image data generated round about the time when transmission is interrupted can be also transmitted.

Especially in case of a surveillance camera, it is desirable that images picked up round about the time when communication is disconnected should be of high picture quality. This is because that the disconnection of the communication line might be caused by some unusual situation on the monitored side. The picture quality of transmitted image data is adjusted by increasing or decreasing the data compression ratio at the compressing unit 103: at higher data compression ratios, coarse images of smaller amounts of data are obtained, and at lower compression ratios, higher-quality images of larger amounts of data are obtained.

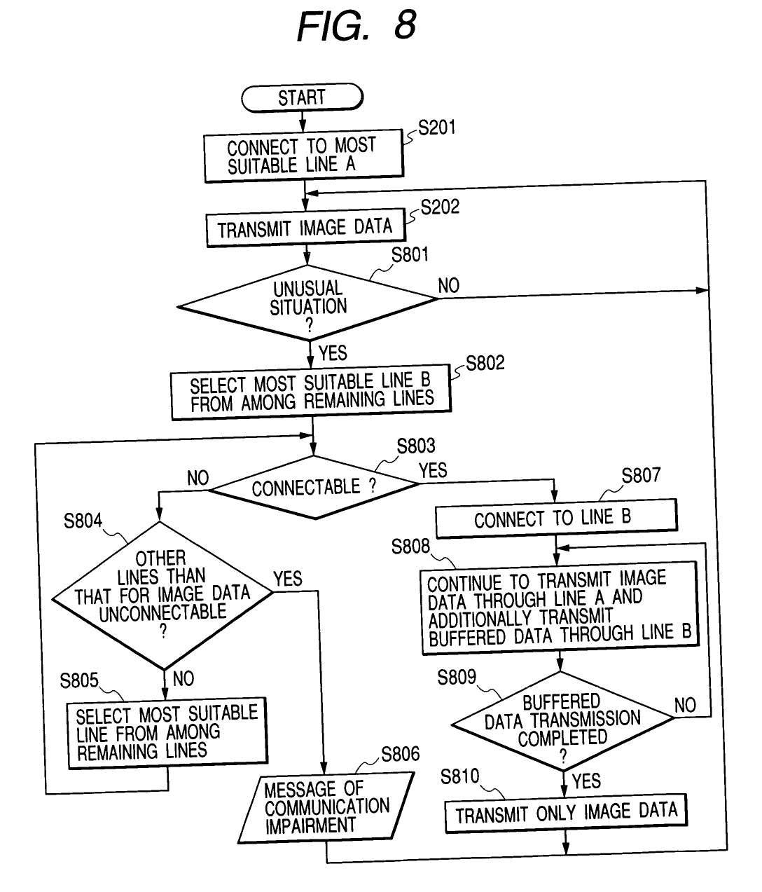

Referring to FIG. 1 and FIG. 8, the fifth embodiment of the video camera device of the present invention will be described. The operation performed in the fifth embodiment when images picked up by the network surveillance camera 101 are outputted to the monitoring-side monitor 122 is the same as in the fourth embodiment. Therefore, the description thereof will be omitted.

Next, referring to FIG. 1 and the flowchart in FIG. 8, description will be given to the operation performed in the following case: while image data is being transmitted from the network surveillance camera 101, the anomaly detecting portion 105 of the network surveillance camera 101 detects something unusual. The example of anomaly detection described here refers to the following case: a suspicious individual intrudes into an office or a residence monitored, and that person is detected by specific noise picked up by a microphone installed on the anomaly detecting portion 105, an infrared sensor for detecting intruders, or motion detection based on image data from the camera 102.

When a request to transmit is made from the controller 121, the control portion 106 connects to communication line A of the highest priority and transmits image data (Steps 201 and 202).

Where the anomaly detecting portion 105 does not detect any anomaly at this time, the data transmission is made through the connected line. If the anomaly detecting portion 105 detects any anomaly, such as intrusion of a suspicious individual (Step 801), the control portion 106 selects the most suitable communication line B from among the remaining lines (Step 802).

When the selected communication line B is connectable, the control portion 106 connects thereto (Steps 803 and 807). Then, the control portion 106 continues to transmit image data outputted from the compressing unit 103 through the communication line A (Step 808). At the same time, the control portion 106 transmits image data generated round about the time when the anomaly was detected by the anomaly detecting portion 105, among image data stored in the buffer 104, through the communication line B (Step 808). Image data stored in the buffer 104 is transmitted as high-quality image data. For this purpose, the data compression ratio of compressing portion B 114 of the compressing unit 103 is made lower than that of the compressing portion A 113. Thus, when image data is stored in the buffer 104, the picture quality thereof is higher than image data transmitted through the compressing portion A 113. When the transmission of data in the buffer 104 is completed, the control portion 106 disconnects the communication line B (Steps 809 and 810).

If the selected communication line B is not connectable at Step 803, the control portion 106 checks whether the still remaining lines are connectable (Step 804). If so, the control portion 106 selects a line of the highest priority from among the still remaining lines (Step 805). If there is not a line through which communication can be conducted, other than the communication line A, the control portion 123 of the controller 121 displays a message on the monitor 122 (Step 806). The message indicates that the transmission of buffered data is infeasible. In this case, only the image data outputted from the compressing portion 103 is continuously transmitted through the communication line A.

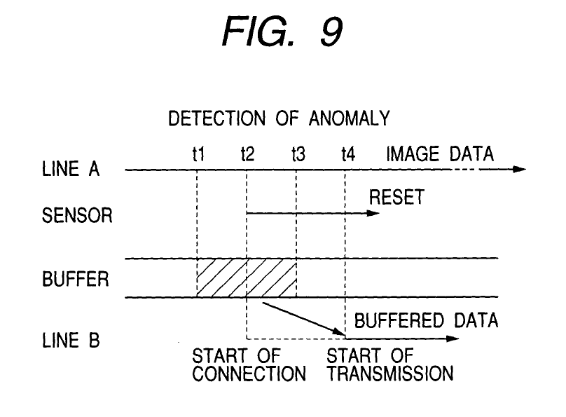

With respect to the above-mentioned fifth embodiment, referring to FIG. 9, detailed description will be given again to the operation performed in the following case: the anomaly detecting portion 105 detects something unusual while image data is being transmitted.

The figure is a schematic diagram wherein both the flow of time and the flow of data are represented in the horizontal direction. It is assumed that, while image data outputted from the compressing portion A 113 of the compressing unit 103 is being transmitted through the communication line A, some anomaly is detected at t2. At this time, another communication line B is selected and connection is started. When the connection to the communication line B is established at t4, high-quality image data stored in the buffer 104 round about the time when the anomaly was detected, that is, during the period from t1 to t3, is transmitted through the communication line B. When the transmission of the buffered data is completed, the communication line B is disconnected.

In the fifth embodiment of the video camera device, as mentioned above, if any anomaly is detected while image data is being transmitted, another communication line B is newly connected. Then, high-quality image data generated and stored in the buffer 104 round about the time when the anomaly was detected is transmitted through this communication line. As a result, image data generated round about the time when the anomaly was detected can be transmitted with high picture quality. Especially in case of a surveillance camera, it is desirable that images picked up round about the time when some anomaly occurs on the monitored side should be of high picture quality.

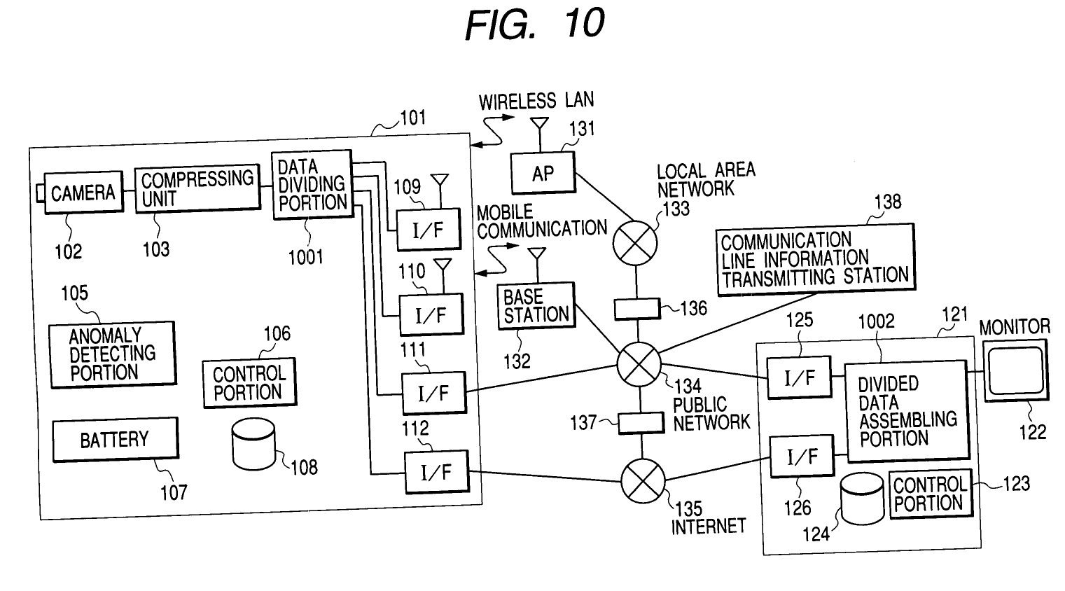

Next, referring to FIG. 10, the sixth embodiment of the video camera device of the present invention will be described.

FIG. 10 is intended to explain the operation performed when images picked up by the network surveillance camera 101 are outputted to the monitoring-side monitor 122. The portions which perform the same operation as in the first embodiment will be provided with the same numbers and the description thereof will be omitted.

There are some differences between the monitoring system illustrated in FIG. 10 and the monitoring system illustrated in FIG. 1. In FIG. 10, the network surveillance camera 101 is provided with a data dividing portion 1001. The data dividing portion 1001 divides image data from the compressing unit 103 into a number equivalent to the number of connectable communication line. Further, in FIG. 10, the controller 121 is provided with a divided data assembling portion 1002. The divided data assembling portion 1002 assembles received image data from the network surveillance camera 101 which data is divided and transmitted through a plurality of lines.

Next, with respect to FIG. 10, description will be given to the operation performed when images picked up by the network surveillance camera 101 are outputted to the monitoring-side monitor 122.

The data of images obtained by shooting a monitored object by the camera 102 is compressed by the compressing portion B 114 of the compressing unit 103. The compressed data is thereafter stored in the buffer 104 for a certain period of time. Further, the image data from the camera 102 is compressed by the compressing portion A 113 of the compressing unit 103 and inputted to the data dividing portion 1001. The control portion 106 turns on the communication interfaces 109 to 112 to connect to the respective communication lines. The control portion 103 checks for communication lines through which communication can be conducted, and determines a divisor for the data dividing portion 1001. This divisor is determined in correspondence with the number of communication lines through which communication can be conducted. Then, the control portion 106 outputs image data divided to communication interfaces corresponding to the communication lines through which communication can be conducted. Thus, image data is divided and transmitted.

Further, the controller 121 turns on communication interfaces corresponding to the number of divided pieces of image data transmitted. Then, the controller 121 receives the divided image data from the network surveillance camera 101, and outputs the received image data to the divided data assembling portion 1002. The divided data assembling portion 1002 assembles the divided image data inputted, and outputs the assembled image data to the monitor 122. While image data is being transmitted using a plurality of communication lines, any of the lines in communication may be disconnected due to communication failure or reduction in communication speed. In this case, the divisor for the data dividing portion 1001 and the divided data assembling portion 1002 is changed. Thus, image data can be transmitted through the remaining lines through which communication can be conducted.

As mentioned above, in the sixth embodiment of the video camera device of the present invention, image data is divided and transmitted through a plurality of communication lines. Thus, the communication speed can be increased as compared with a case where image data is transmitted through one communication line. Therefore, a video camera device capable of transmitting high-quality image data larger in amount is obtained. Further, in the sixth embodiment, even if any of a plurality of communication lines is disconnected while image data is being transmitted, the image data can be transmitted through the remaining lines. Therefore, a video camera device less prone to be influenced by the communicating conditions of communication lines is obtained.

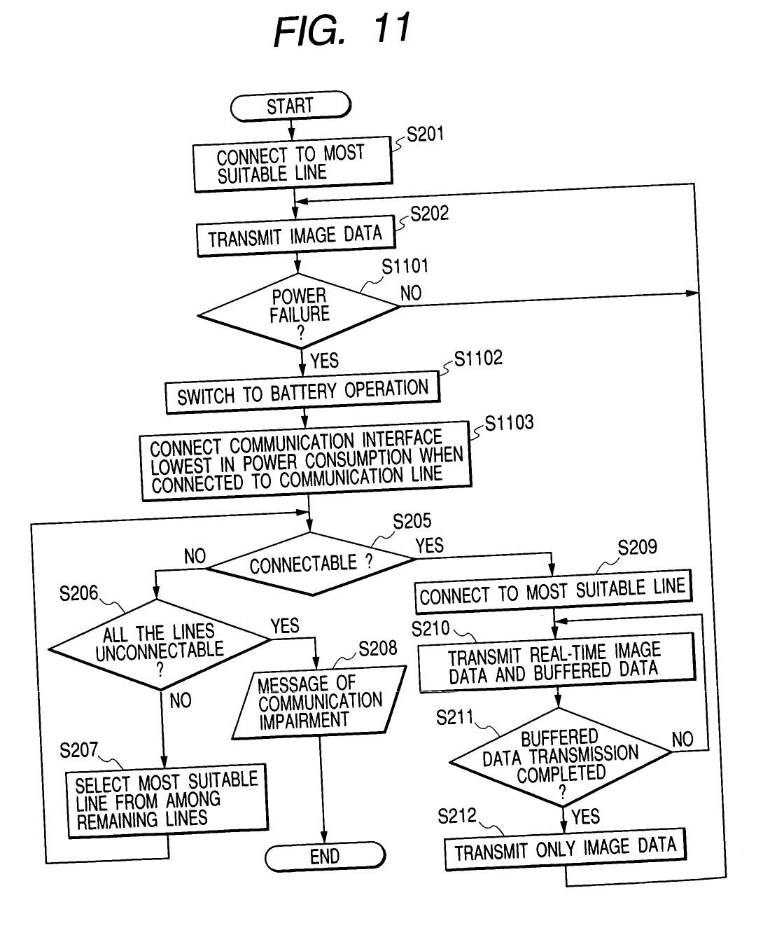

Next, referring to FIG. 1 and FIG. 11, the seventh embodiment of the video camera device of the present invention will be described. The operation performed in the seventh embodiment when images picked up by the network surveillance camera 101 are outputted to the monitoring-side monitor 122 is the same as in the first embodiment. Therefore, the description thereof will be omitted.

Next, referring to FIG. 1 and the flowchart in FIG. 11, description will be given to the operation performed in the following case: external power supply to the network surveillance camera 101 is interrupted due to some trouble, such as power failure, and the power source is switched to the battery 107 loaded in the surveillance camera.

When a request to transmit is made from the controller 121, the control portion 106 refers to information about the conditions of the communication lines, stored in the storage device 108. Based on this information, the control portion 106 connects the controller 121 to a communication line of the highest priority (the Internet 135 in the example), and the transmission of image data is made (Steps 201 and 202).

If power failure occurs while the image data is being transmitted (Step 1101), the control portion 106 switches the power source to the battery 107 (Step 1102).

At this time, the control portion 106 selects a communication interface corresponding to a communication line lowest in power consumption when connected (Step 1103).

When the communication line corresponding to the selected communication interface is connectable, the control portion 106 transmits image data generated and stored in the buffer 104 while the line is disconnected, together with image data outputted from the compressing portion A 113 of the compressing unit 103 (Steps 205, 209, and 210). If the selected communication line is not connectable, the control portion 106 establishes connection through the remaining lines (Steps 205, 206, and 207).

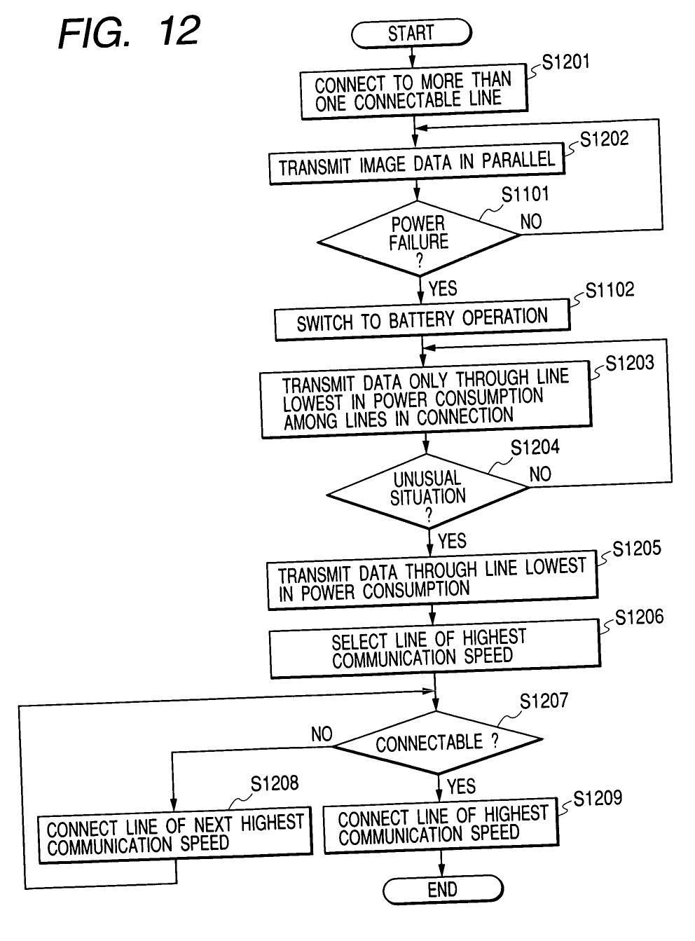

Next, referring to FIG. 10 and FIG. 12, the eighth embodiment of the video camera device of the present invention will be described. The operation performed in the eighth embodiment when images picked up by the network surveillance camera 101 are outputted to the monitoring-side monitor 122 is the same as in the sixth embodiment. Therefore, the description thereof will be omitted.

Next, referring to FIG. 10 and the flowchart in FIG. 12, description will be given to the operation performed in the following case: external power supply to the network surveillance camera 101 is interrupted due to some trouble, such as power failure, and the power source is switched to the battery 107 loaded in the surveillance camera.

When a request to transmit is made from the controller 121, the control portion 106 connects to a plurality of connectable communication lines and transmits divided image data in parallel (Steps 1201 and 1202).

If power failure occurs while the image data is being transmitted (Step 1101), the control portion 106 switches the power source to the battery 107 (Step 1102).

At this time, the control portion 106 transmits image data only through a communication line lowest in power consumption, among a plurality of the communication lines which are in communication (Step 1203). The control portion 106 disconnects the remaining communication lines (Step 1203). The communication speed of the transmitted image data is adjusted at the communication interface in correspondence with the transmission speed of the selected line. Where the anomaly detecting portion 105 does not detect any anomaly while image data is being transmitted only through the communication line lowest in power consumption, data transmission is made through the connected line.

If the anomaly detecting portion 105 detects any anomaly, such as intrusion of a suspicious individual (Step 1204), the control portion 106 selects a communication line lowest in power consumption among the remaining lines, and transmits data.

Subsequently, the control portions 160 selects a communication line highest in communication speed from among the remaining communication lines (Step 1206). When the selected communication line is connectable, the control portion 106 connects thereto and starts the transmission of image data (Steps 1207 and 1209). Since the line highest in communication speed is selected, the power consumption of the network surveillance camera 101 is increased; however, the image data transmitted at this time is of the highest picture quality.

If the selected communication line is not connectable at Step 1207, the control portion 106 selects a line of the next highest communication speed (Step 1208).

In the above-mentioned eighth embodiment of the video camera device, the network surveillance camera 101 is battery-driven at the time of power failure. Therefore, image data can be transmitted even at the time of power failure. Further, in the eighth embodiment, image data is transmitted only through a line of the lowest power consumption among a plurality of communication lines in connection. Therefore, the battery life can be lengthened. Further, in the eighth embodiment, if any anomaly detected while the camera is battery-operated, the line is switched to a line of the highest communication speed. Therefore, in case of an unusual situation, higher-quality image data can be transmitted.

In accordance with the present invention, a transmitting device, a video camera device, and a transmitting method for the transmitting device wherein, even if a communication line is disconnected while data is being transmitted, the data can be transmitted are obtained. Further, in accordance with the present invention, a transmitting device, a video camera device, and a transmitting method for the transmitting device wherein data generated while a communication line is disconnected can be also transmitted are obtained. Further, in accordance with the present invention, a transmitting device, a video camera device, and a transmitting method for the transmitting device wherein communication lines not in communication can be effectively utilized while data is being transmitted are obtained. Further, in accordance with the present invention, a transmitting device, a video camera device, a transmitting method for the transmitting device, and a transmitting method for the video camera device wherein data indicating change in the situations of the transmitting device and the surrounding situations can be transmitted are obtained. Further, in accordance with the present invention, a transmitting device, a video camera device, a transmitting method for the transmitting device wherein higher-quality image data large in amount can be transmitted and further, even if a communication line is disconnected while data is being transmitted, the data can be transmitted are obtained. Further, in accordance with the present invention, a transmitting device capable of transmitting data even at the time of power failure.

The foregoing invention has been described in terms of preferred embodiments. However, those skilled, in the art will recognize that many variations of such embodiments exist. Such variations are intended to be within the scope of the present invention and the appended claims.

What is claimed is:

1. A transmitting device which is provided with a plurality of communication interfaces connectable to a plurality of respective communication lines and transmits data through the communication interface, wherein, if a communication line is disconnected while data is being transmitted, an appropriate communication line is selected based on predetermined criteria for communication line connection; a communication interface corresponding to the communication line is driven to establish connection with the communication line; and the data is transmitted.

2. A transmitting device which is provided with a plurality of communication interfaces connectable to communication lines and transmits data through the communication interfaces, the transmitting device further comprising a data storing means for storing data to be transmitted, wherein, if a communication line is disconnected while data is being transmitted, an appropriate communication line is selected based on a predetermined criteria for communication line connection; a communication interface corresponding to the communication line is driven to establish connection with the communication line; and said data generated and stored in said data storing means while the communication line is disconnected is transmitted together with data to be transmitted.

3. A transmitting device which is provided with a plurality of communication interfaces connectable to communication lines and transmits data through the communication interfaces, the transmitting device further comprising a data storing means for storing data to be transmitted, wherein, while data is being transmitted, communication interfaces which are not transmitting are driven to connect communication lines corresponding to the communication interfaces; and the conditions of the communication line are examined to obtain up-to-date information about the conditions of the communication lines, and wherein, if a communication line is disconnected while data is being transmitted, an appropriate communication line is selected based on criteria for communication line connection updated with said up-to-date information; a communication interface corresponding to the communication line is driven to establish connection with the communication line; and said data generated and stored in said data storing means while the communication line is disconnected is transmitted together with data to be transmitted.

4. A transmitting device which is provide with a plurality of communication interfaces connectable to communication lines and transmits data through the communication interfaces, the transmitting device further comprising a data storing means for storing data to be transmitted, wherein, while data is being transmitted, a communication interface which is not transmitting is selected to connect a communication line corresponding to the communication interface; and up-to-date information about the conditions of communication lines is externally acquired through the communication line, and wherein, if a communication line is disconnected while data is being transmitted, an appropriate communication line is selected based on criteria for communication line connection with said up-to-date information taken into account; a communication interface corresponding to the communication line is driven to establish connection with the communication line; and said data generated and stored in said data storing means while the communication line is disconnected, is transmitted together with data to be transmitted.

5. A transmitting device which is provided with a plurality of communication interfaces connectable to communication lines and transmits data through the communication interfaces, the transmitting device further comprising a data storing means for storing data to be transmitted, wherein, if a communication line is disconnected while data is being transmitted, a plurality of communication lines are selected based on predetermined criteria for communication line connection; a plurality of communication interfaces corresponding to a plurality of the communication lines are driven to establish connection with a plurality of the communication lines; and said data generated and stored in said data storing means while the communication line is disconnected and data to be transmitted are transmitted through different communication lines among the a plurality of the connected communication lines.

6. A transmitting device which is provided with a plurality of communication interfaces connectable to communication lines and transmits data through the communication interfaces, the transmitting device further comprising a data storing means for storing data to be transmitted and a sensor for detecting any change in the situations of said transmitting device or the surrounding situations, wherein, if said sensor detects said change in the situations while data is being transmitted, the transmission of the data is continued and further a communication interface which is not in communication is connected; a communication line corresponding to the communication interface is connected; and data generated and stored in said data storing means round about the time when said sensor detected said change in the situations is transmitted through the communication line.

7. A video camera device which is provided with an image pickup portion; a compressing portion which compresses the data of images picked up by the image pickup portion; and a transmitting device which includes a plurality of communication interfaces connectable to communication lines and transmits compressed image data compressed by said compressing portion through the communication interfaces, the video camera device further comprising a data storing means which stores high-image quality data lower in data compression ratio than compressed image data to be transmitted; and a sensor for detecting any change in the situations of said transmitting device or the surrounding situations, wherein, if said sensor detects said change in the situations while said compressed image data is being transmitted, a communication interface which is not transmitting is driven to connect a communication line corresponding to the communication interface; and said high-picture quality data stored in said data storing means is transmitted.

8. A transmitting device which is provided with a data dividing portion which divides data to be transmitted and transmits pieces of data divided by the data dividing portion in parallel using a plurality of communication interfaces, wherein, if a communication line is disconnected while data is being transmitted, the data to be transmitted divided by said data dividing portion is re-divided into a number corresponding to the number of the remaining communication lines and the re-divided data is transmitted through said remaining communication lines.

9. The transmitting device according to claim 1, further comprising a battery, wherein at the time of power failure, the power supply to said transmitting device is switched to said battery, and if said transmitting device is transmitting data at this time, a communication interface corresponding to a communication line lowest in power consumption when connected is selected from among a plurality of communication interfaces to establish connection with the communication line, and data is transmitted.

10. The transmitting device according to claim 8, further comprising a battery, wherein, at the time of power failure, the power supply to said transmitting device is switched to said battery and, if said transmitting device is transmitting divided data using a plurality of communication lines at this time, only a communication interface corresponding to a communication line lowest in power consumption is selected from among a plurality of communication interfaces in communication and driven to establish connection with the communication line, and data is transmitted.

11. The transmitting device according to claim 9, further comprising a sensor for detecting any change in the situations of said transmitting device or surrounding situations, wherein, if said sensor detects said change in the situations while said transmitting device is transmitting data through a communication interface lowest in power consumption at the time of power interruption, a communication interface corresponding to a communication line highest in communication speed among a plurality of said communication interfaces is selected and driven, and data is transmitted.

12. The transmitting device according to claim 1, wherein said criteria for communication line connection include at least one of the following: communication speed, communication cost, power consumption, the reliability of line connection, the conditions of communication lines, the conditions of the transmitting device, and the conditions of a receiver as the destination of transmission.

13. A transmitting method for a transmitting device which is provided with a plurality of communication interfaces connectable to communication lines and transmits data through the communication interfaces, wherein, if a communication line is disconnected while data is being transmitted, a communication interface corresponding to another communication line is driven to establish connection with the communication line and data is transmitted.

14. A transmitting method for a transmitting device which is provided with a plurality of communication interfaces connectable to communication lines and transmits data through the communication interfaces, wherein, if a communication line is disconnected while data is being transmitted, a communication interface corresponding to another communication line is driven to establish connection with the communication line, and said data stored while the communication line is disconnected is transmitted together with data to be transmitted.

15. A transmitting method for a transmitting device which is provided with a plurality of communication interfaces connectable to communication lines and transmits data through the communication interfaces, wherein, if a communication line is disconnected while data is being transmitted, a plurality of communication interfaces corresponding to a plurality of other communication lines are driven to establish connection with a plurality of the communication lines, and data stored while the communication line is disconnected and data to be transmitted are transmitted through different communication lines among a plurality of said connected communication lines.

16. A transmitting method for a transmitting device which is provided with a plurality of communication interfaces connectable to communication lines and transmits data through the communication interfaces, wherein, if there is any change in the situations of said transmitting device or the surrounding situations while data is being transmitted, the transmission of the data is continued and further a communication interface not in communication is connected to establish connection with a communication line corresponding the communication interface, and data generated round about the time when the said change in the situations occurred is transmitted.

17. A transmitting method for a video camera device which is provided with an image pickup portion; a compressing portion which compresses the data of images picked up by the image pickup portion; and a transmitting device which is provided with a plurality of communication interfaces connectable to communication lines and transmits compressed image data compressed by said compressing portion through the communication interfaces, wherein, if said sensor detects said change in the situations while said compressed image data is being transmitted, a communication interface which is not transmitting is driven to connect a communication line corresponding to the communication interface, and high-picture quality data lower in data compression ratio than said compressed image data stored is transmitted.

18. A transmitting method for a transmitting device, wherein a plurality pieces of data obtained by dividing data to be transmitted are transmitted in parallel using a plurality of communication interfaces, and, if a communication line is disconnected while the data is being transmitted, the data to be transmitted is re-divided into a number corresponding to the number of the remaining communication lines and the re-divided data is transmitted through the remaining communication lines.
